(19) United States
(12) Patent Application Publication
(10) Pub. No.: US 2005/0063553 A1
(43) Pub. Date: Mar. 24, 2005

(54) Microphone apparatus, noise reduction method and recording apparatus

(76) Inventor: Kazuhiko Ozawa, Kanagawa (JP)

Correspondence Address: William S. Frommer, Esq.;FROMMER LAWRENCE & HAUG LLP, 745 Fifth Avenue, New York, NY, 10151, US

(21) Appl. No.: 10/903,800

(22) Filed: Jul. 31, 2004

(30) Foreign Application Priority Data
Aug. 1, 2003 (JP) 2003-285294

(51) Int. Cl. H04R 1/02; H04R 3/00

(52) U.S. Cl. 381/92; 381/91; 381/122

(57) ABSTRACT

To achieve vibration-dependent noise reduction by the use of a microphone to pick up an audio signal and a vibration sensor. The microphone apparatus according to a preferred embodiment of the present invention is one having one or more microphone, one or more sensor, noise extraction means for extracting the noise bandwidth section from the output signal of the sensor, an adaptive filter coordinated with the microphone for receiving the output signal of the noise extraction means as the reference input signal, and an adder for subtracting the output signal of the adaptive filter from the output signal of the microphone, wherein the vibration detection directions of the microphone and the sensor match, and so do the output polarities of the vibration signal.

### CROSS REFERENCE TO RELATED APPLICATIONS

The present document is based on Japanese Priority Application JP2003-285294 filed in the Japanese Patent Office on Aug. 1, 2003, the content in which being incorporated herein by reference to the extent permitted by law.

### BACKGROUND OF THE INVENTION

1. Field of the Invention

The present invention relates to a microphone apparatus and a noise reduction method which are suitable for use in recording apparatus having a built-in camera, for example.

2. Description of the Related Art

The applicant of this patent application has proposed in an earlier patent application, Japanese Application Publication No. 2002-367234, a microphone apparatus and a vibration-dependent noise reduction method and apparatus having a plurality of microphone units which are disposed in opposed relationship. This is a so-called sensorless noise reduction technique because a microphone to pick-up an audio signal is also used as a vibration sensor.

However, the microphone units to be used in such reduction technique must satisfy the following requirements. Firstly, non-directional microphone units having non directional characteristics must be used. Secondly, the microphone units must be disposed close to one another with their sound receiving faces thereof facing to one another. Thirdly, the use of a plurality of microphone units is essential.

In addition, Japanese Patent Application Publication No. H8-272377 discloses a noise reduction apparatus including a sensor for detecting a signal having strong correlation to a noise, an adaptive FIR filter for generating a cancellation signal which is opposite in phase to the noise and the same acoustic pressure as the noise based on the detected signal, an adder for combining the generated cancellation signal and the noise signal from the built-in microphone, and coefficient renewal means for sequentially calculating and renewing coefficients of the adaptive FIR filter in order to maximize the amount of reduction of the noise based on the residual signal resulting from the combination by the adder.

### SUMMARY OF THE INVENTION

As a result, some problems arise in cases where requirements of the microphone units as described in Japanese patent application No. 2002-367234 are not satisfied, such as when a directional microphone unit like a unidirectional microphone or the like is used, in monaural microphone apparatus employing a single microphone unit, in apparatus of such construction as employing microphones disposed far apart with considerable distance therebetween, and the like.

On the contrary, as shown in FIG. 13 (A), a preferred embodiment of the present invention employs a microphone apparatus in which vibration detection directions of a microphone 92 and a sensor 93, or the output polarities of the vibration signals in addition thereto are made in agreement, a noise bandwidth section of a noise source 91 is extracted by noise extraction means from the output signal of the sensor 93, a pseudo noise signal 98 corresponding to the microphone 92 is further outputted by an adaptive filter 95 using the output signal of the noise extraction means as a reference input signal 97, and the output signal of the adaptive filter 95 is removed from the output signal of the microphone 92 by noise rejection means 94.

Although Japanese Patent Application Publication No. H8-272377 discloses a technique to detect by sensor a signal having high correlation to noise which is to be rejected, and to generate a cancellation signal for reducing the noise by an adaptive filter based on the detected signal, its noise reduction performance is poor. On the contrary, the present invention differs from it in that, in order to improve the noise reduction performance by further enhancing correlation between the signal of the sensor and the noise signal of the microphone, vibration detection directions of the microphone and the sensor, or the output polarities in addition thereto are made in agreement.

In addition, as shown in FIG. 13 (B), according to another preferred embodiment of the present invention, the reference signal 97 having high correlation to noise to be inputted to the adaptive filter 95 is obtained from a difference signal of a plurality of microphones 92 rather than the sensor 93, and the sensor 93 is used only as an ON/OFF signal 99 for noise reduction processing by the noise rejection means 94.

As apparent from the foregoing, merits of extracting the reference signal 97 to be inputted to the adaptive filter 95 by the microphones 92 rather than the sensor 93 include that, since the noise signal 96 to be rejected and the reference signal 97 are obtained from the microphones 92 which are mounted on the same position, there is no delay time difference between the both signals and the correlation is relatively high. Accordingly, the pseudo noise signal 98 can be easily generated by the adaptive filter 95. On the contrary, in case of separating the microphones 92 and the sensor 93, experiments have been made by the applicants to prove that the difference in mounting location causes different transmission characteristics from a noise source 91, thereby making the adaptive filter 95 more complicate in construction because of the need for correcting the delay time difference and making it difficult to improve noise reduction performance because of possibly poor correlation between them.

The present invention has been conceived in consideration of the above circumstances and it proposes to realize vibration dependent noise reduction even in the above cases by providing a microphone to pick up an audio signal and further a vibration sensor.

Moreover, in recent years, a vibration sensor known as an impact sensor or a shock sensor is built in a disk device such as an HDD (Hard Disk Drive), a DVD (Digital Versatile Disk), a CD-R (write once) or the like for the purpose of enhancing the vibration resistance performance of such device. In a built-in camera type video recording/play-back (reproducing) apparatus including an HDD which is believed to be the mainstream product in future, the vibration sensor in the HDD is commonly used for easily detecting and reducing vibration noise, which is generated from such device, without providing an additional sensor.

A microphone apparatus according to a preferred embodiment of the present invention includes one or more microphones, one or more sensors, a noise extraction means for extracting a noise bandwidth section in an output signal from the sensor, an adaptive filter for each microphone which receives the output signal of the noise extraction means as a reference input signal, and a operation means for subtracting the output signal of the adaptive filter from the output signal of the respective microphone, wherein directions of vibration detection of the microphone and the sensor match, or, in addition, output polarities of the vibration signals of the microphone and the sensor match.

According to the preferred embodiment of the present invention, since there is no restriction of disposing at least two or more non-directional microphone units close to each other and in an opposed relationship, the noise reduction circuit according to the preferred embodiment of the present invention is capable of canceling vibration dependent noise from the audio signal of the microphone even in devices such as, for example, those employing a single microphone, a directional microphone having a unidirectional characteristic or the like, or in apparatus having a construction where opposed disposition is impossible.

Also, a microphone apparatus according to another preferred embodiment of the present invention includes a plurality of microphones, one or more sensor, a first operation means for outputting a difference component between the output signals from the plurality of microphones, a noise extraction means for extracting a noise bandwidth section in the output signal of the first operation means, an adaptive filter for each microphone for receiving the output signal of the noise extraction means as a reference signal, and a second operation means for subtracting the output signal of the adaptive filter from the output signal of the respective microphone, wherein directions of vibration detection of the microphone and the sensor match, or, in addition, output polarities of the vibration signals of the microphone and the sensor match and noise reduction is inhibited by not carrying out the subtraction by the second operation means if the signal level of the sensor is equal to or lower than a designated level.

According to the preferred embodiment of the present invention, the use of a vibration sensor together with a plurality of microphone units makes it possible to accurately pick up and use only the target vibration noise, thereby enabling to cancel out the vibration dependent noise from the audio signal of the microphone without the need for disposing the microphone unit in an opposed relationship.

Moreover, the noise reduction method according to another preferred embodiment of the present invention employs a microphone apparatus having one or more microphones, one ore more sensors, a noise extraction means for extracting a noise bandwidth section from the output signal of the sensor, an adaptive filter for each microphone to receive the output signal of the sensor as a reference input signal, and an operation means for subtracting the output signal of the adaptive filter from the output signal of each microphone, wherein directions of vibration detection of the microphone and the sensor match, or, in addition, output polarities of the vibration signals of the microphone and the sensor match, the method including the steps of extracting a noise bandwidth section from the output signal of the sensor by the noise extraction means, further outputting a pseudo noise signal corresponding to the respective microphone by inputting the output signal of the noise extraction means by the adaptive filter, and subtracting the output signal of the adaptive filter from the output signal of the respective microphone by the operation means.

According to another preferred embodiment of the present invention, it is possible to cancel vibration dependent noise in the audio signal from a microphone by the noise reduction processing of the present invention even in cases such as, for example, when only a single microphone is used, a directional microphone having a unidirectional characteristic or the like is used, or when an apparatus has a construction in which disposition in an opposed relationship is impossible, because there is no restriction of disposing at least two or more microphones close together and in opposed relationship like in the earlier patent application.

Also, the noise reduction method according to a preferred embodiment of the present invention is used in a microphone apparatus having a plurality of microphones, one or more sensor, first operation means for outputting a difference component between output signals of a plurality of microphones, noise extraction means for extracting a noise bandwidth section from the output signal of the first operation means, an adaptive filter corresponding to the respective microphone by receiving the output signal of the noise extraction means as the reference input signal and second operation means for subtracting the output signal of the adaptive filter from the respective microphone, wherein directions of vibration detection of the microphone and the sensor match, or, in addition, output polarities of the vibration signals of the microphone and the sensor match, and the method comprises the steps of outputting a difference component between the output signals of a plurality of microphones by the first operation means, extracting a noise bandwidth section in the output signal of the first operation means, outputting a pseudo noise signal corresponding to the respective microphones with the output signal of the noise extraction means as the reference input signal by the adaptive filter, subtracting the output signal of the adaptive filter from the output signal of the respective microphone by the second operation means, and prohibiting the subtraction by the second operation means when the signal level of the sensor is equal to or less than a designated level.

According to a preferred embodiment of the present invention, by using a plurality of microphone units together with the vibration sensor, the vibration dependent noise can be cancelled out from the audio signal of the microphone without disposing microphone units in an opposed relationship like the case in the earlier patent application, because noise reduction processing can be performed by accurately picking up only the target vibration noise.

Also, the recording apparatus according to a preferred embodiment of the present invention uses a microphone apparatus having one or more microphones, one or more a noise extraction means for extracting a noise bandwidth section from the output signal of the sensor, an adaptive filter for each microphone for receiving the output signal of the noise extraction means as the reference input signal, and an operation means for subtracting the output signal of the adaptive filter from the output signal of the respective microphone, thereby recording the output signal of the microphone on a recording medium by recording means which is driven by driving means, wherein directions of vibration detection of the microphone and the sensor match, or, in addition, output polarities of the vibration signals of the microphone and the sensor match.

According to a preferred embodiment of the present invention, the microphone apparatus which performs noise reduction according to a preferred embodiment of the present invention is capable of canceling only the vibration dependent noise from the audio signal of the microphone even in the recording apparatus such as, for example, those using a single microphone, using a directional microphone having unidirectional characteristic or the like, or having the construction in which opposed disposition is impossible, because there is no restriction of disposing at least two or more non-directional microphone units close to one another and in an opposed relationship like in the earlier patent application.

Also, the recording apparatus according to a preferred embodiment of the present invention is for recording the output signal of a microphone apparatus having a plurality of microphones, one or more sensors, a first operation means for outputting difference components between output signals of the plurality of microphones, noise extraction means for extracting the noise bandwidth section in the output signal of the first operation means, an adaptive filter for each microphone for receiving the output signal of the respective microphone as the reference input signal, and a second operation means for subtracting the output signal of the adaptive filter from the output signal of the respective microphone, wherein directions of vibration detection of the microphone and the sensor match, or, in addition, output polarities of the vibration signals of the microphone and the sensor match, and noise reduction is prohibited by not performing the subtraction of the second operation means when the signal level of the sensor is equal to or lower than a designated level.

According to a preferred embodiment of the present invention, by using a plurality of microphone units together with the vibration sensor, it is possible to accurately pick up and use only the target vibration noise, thereby canceling out the vibration dependent noise from the audio signal of the microphone and recording only the audio signal even in the recording apparatus having a construction in which microphone units cannot be disposed in an opposed relationship like in the earlier patent application.

For example, by commonly using the vibration sensor, the impact sensor or the shock sensor which is built in a disk device such as an HDD, a DVD, a CD, a CD-R or the like for the purpose of improving vibration resistant performance, the recording apparatus according to a preferred embodiment of the present invention is capable of detecting and reducing vibration noise which is generated in such apparatus without providing a new or additional sensor.

Therefore, the microphone apparatus according to the preferred embodiments of the present invention proposes a noise reduction technique which uses a sensor for converting vibration into electrical signal, thereby reducing vibration dependent noise by using the sensor together with the microphone. Since there is no restriction in locations of the microphone unit and the sensor, the microphone apparatus according to the preferred embodiment of the present invention can be used in a wide range of electrical machines and appliances. Moreover, by making the vibration detection directions of the microphone and the sensor or the output polarities in addition thereto in agreement and by improving the converging characteristic of the adaptive filter, reduction effect can be achieved even with small number of taps.

Furthermore, since subtraction by the second operation means is interrupted when the signal level from the sensor is equal to or less than a designated level, it is possible to accurately pick up and reduce only the target vibration noise.

On the other hand, the noise reduction method according to the preferred embodiment of the present invention is capable of reducing noise of a wide range of electrical machines and appliances to which the microphone apparatus according to the preferred embodiment of the present invention is applied, by using the sensor together with the microphone for reducing vibration dependent noise, because there is no restriction to the location of the microphone unit and the sensor. Again, by making directions of vibration detection of the microphone and the sensor match, or, in addition, output polarities of the vibration signals of the microphone and the sensor match, it is possible to improve the correlation between them and improve converging characteristics of the adaptive filter, thereby achieving reduction effect by filter processing with small number of taps.

In addition, by interrupting the subtraction by the second operation means when the signal level from the sensor is equal to or less than a designated level, it is possible to accurately pick up only targeted vibration noise by the sensor and reduce such noise.

The recording apparatus according to the preferred embodiments of the present invention still proposes a noise reduction technique using the sensor for converting vibration into electrical signal and thus reducing vibration dependent noise by using the sensor together with the microphone. Since there is no restriction to location of the microphone unit and the sensor, it is possible to use the microphone for reducing noise of a wider range of recording apparatus than prior arts, thereby enabling to cancel out noise and record only the audio signal. Again, by making the vibration detection directions of the microphone and the sensor or the output polarities in addition thereto in agreement, it is possible to improve the correlation and improve the converging characteristic of the adaptive filter, thereby achieving reduction effect with small number of taps.

Moreover, by interrupting the subtraction by the second operation means when the signal level of the sensor is equal to or less than a designated level, it is possible to accurately pick up by the sensor and reduce only the target vibration noise, thereby canceling out the noise and recording only the audio signal.

### BRIEF DESCRIPTION OF THE DRAWINGS

The above and other objects and features of the preferred embodiments of the present invention will become more apparent to those of ordinary skill in the art from the following detailed description taken in conjunction with the accompanying drawings in which:

FIG. 1 shows a block diagram of a microphone apparatus according to a first example of preferred embodiment of the present invention;

FIG. 2A and FIG. 2B show output waveforms of a microphone diaphragm and a sensor, wherein FIG. 2A shows the microphone diaphragm and the waveform of the microphone output and FIG. 2B shows the sensor and the waveform of the sensor output;

FIG. 3 shows an example of configuration in which a sensor is installed in a HDD;

FIG. 4 shows a structure of sensor according to an example of preferred embodiment of the present invention;

FIG. 5 shows a structure of sensor according another example of preferred embodiment of the present invention;

FIG. 6 shows a level of output sensitivity of the sensor;

FIG. 7A and FIG. 7B shows polarity and delay time of the output of the sensor, wherein FIG. 7A is the noise generated in the audio microphone, while FIG. 7B is the sensor output;

FIG. 8 shows a block diagram of a LMS adaptive filter;

FIG. 9 shows a block diagram of a microphone apparatus according to a second example of preferred embodiment of the present invention;

FIG. 10 shows a block diagram of a microphone apparatus according to a third example of preferred embodiment of the present invention;

FIG. 11 shows a block diagram of a microphone apparatus according to a fourth example of preferred embodiment of the present invention;

FIG. 12 shows a block diagram of a microphone apparatus according to a fifth example of preferred embodiment of the present invention; and

FIG. 13A and FIG. 13B show diagrams descriptive of differences between the present invention and the related art, in which FIG. 13A is a schematic diagram of a preferred embodiment of the present invention, while FIG. 13B shows a schematic diagram of another preferred embodiment of the present invention.

### DETAILED DESCRIPTION OF THE PREFERRED EMBODIMENTS OF THE INVENTION

In a video camera such as a home use digital video camera and the like, it is most likely to pick up sound by a built-in microphone apparatus. Since downsizing of electrical machines and appliances is accelerated in recent years, a recording apparatus such as a VTR, a disk device or the like and a microphone which is built in such machines and appliances are disposed at closer locations between them, thereby causing a problem that vibration noise and acoustic noise generated by such recording apparatus invade easily into the microphone. Similarly, downsizing may cause a problem that the user unintentionally touches the built-in microphone or surroundings when one is operating various camera features such as zooming or focusing as well as operating switches when taking pictures, thereby introducing undesirable noise through the cabinet and causing uncomfortable touching noise at time of play-back.

Incidentally, in a case of taking pictures (capturing images) in relatively quiet environment, since an internal AGC (Automatic Gain Control) circuit increases the microphone sensitivity, even slight touch noise may be very harsh to the ears. Furthermore, since it is general in a video camera that a non-directional microphone unit is used so that an operation circuit changes it to have a directional characteristic, there are possibilities to cause a problem that the noise frequency bandwidth is enhanced by proximity effect peculiar to directional characteristic, so it is emphasized rather than the intended audio signal.

In order to reduce such noise, it is conventional to float the microphone unit of the built-in microphone from the cabinet by using an insulator such as a rubber dumper or the like or to employ such construction of hanging the microphone unit in air by using a rubber wire or the like, thereby absorbing the vibration which is conducted from the cabinet or preventing conduction of such noise. Unfortunately, such conventional techniques are not enough to completely suppress vibration because such insulator exhibits no effect to strong vibration or vibration of a certain frequency and conversely, there are cases to cause resonance in peculiar frequencies. Accordingly, it makes the mechanical design very difficult and is an obstacle to cost reduction and downsizing.

Furthermore, noise caused by the above mentioned touch noise is not only vibration which is conducted through the cabinet but also acoustic noise conducted simultaneously with the vibration through air, thereby making noise transmission paths to the microphone unit very complicated. Therefore, there is a limitation in noise reduction by the conventional passive methods and thus it is difficult to achieve the level which satisfies the user.

Therefore, the present invention aims at solving the above-mentioned problems without the need for structural measures to isolate the microphone unit but rather positively picking up vibration noise and canceling out the generated vibration noise by means of circuitry. In addition, the picked up vibration noise is supplied to an adaptive filter as the reference input signal for canceling out the acoustic noise which is generated at the same timing.

In the above-mentioned manner, the present invention performs noise reduction processing targeted to all kinds of noise which are generated depending on vibration.

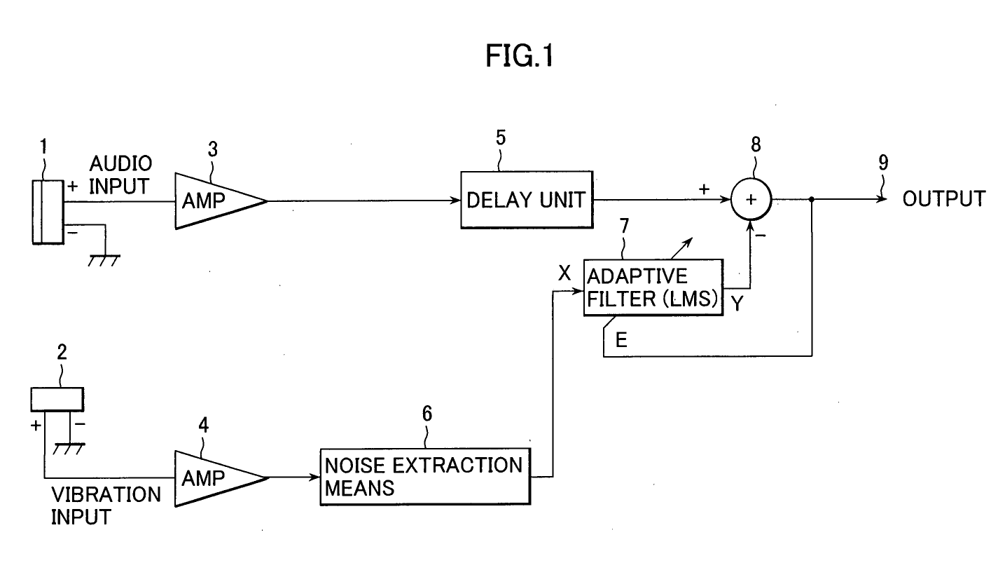

Now, features of the present invention will be described hereunder by reference to FIG. 1, which illustrates a block diagram of an example of the microphone apparatus according to a preferred embodiment of the present invention.

Like the case in the earlier Japanese Patent Application Publication No. 2002-367234 (Noise Reduction Apparatus and Method), the present invention does not require a plurality of microphones for inputting an audio signal and may use a single microphone. Moreover, it is possible to use not only a non-directional microphone but also a directional microphone such as a unidirectional microphone, a bidirectional microphone or the like.

In addition, in FIG. 1, a sensor is used for inputting vibration and the sensor may be mounted at any desired location for converting mechanical vibration into an electrical signal which is inputted as a vibration signal for reduction processing.

Now, the example of preferred embodiment of the microphone apparatus in FIG. 1 will be described hereunder. A microphone 1 may be any desired microphone unit having a minus (−) side output terminal connected to ground GND of the circuit and a plus (+) side output terminal connected to an amplifier AMP 3 for picking up the output signal. On the other hand, a sensor 2 has its minus (−) side terminal connected to ground GND of the circuit, while its plus (+) side terminal is connected to an amplifier AMP 4. A noise bandwidth component of the output signal is further extracted by noise extraction means 6. The noise extraction means 6 comprises an LPF (Low Pass Filter) and/or a BPF (Band Pass Filter) and extracts a bandwidth section of the vibration noises which concentrate at relatively lower zones in the audio bandwidth. And the vibration component is inputted to an adaptive filter 7, which will be described hereinafter, as the reference input X for generating and outputting a pseudo noise signal Y by a designated algorithm.

Then, the audio signal of the AMP 3 is supplied to a delay unit 5 for causing a delay equivalent to the processing time of the noise extraction means 6 and the adaptive filter 7 before being inputted to the plus (+) side terminal of an adder 8 in phase with the pseudo noise signal Y which is inputted to the minus (−) side terminal for outputting from the output terminal 9. Furthermore, the output signal is fed back to the adaptive filter 7 as an error signal E. By operating the adaptive filter 7 so that the error signal will be always the minimum, it is possible to obtain the audio signal reduced the vibration component from the terminal 9.

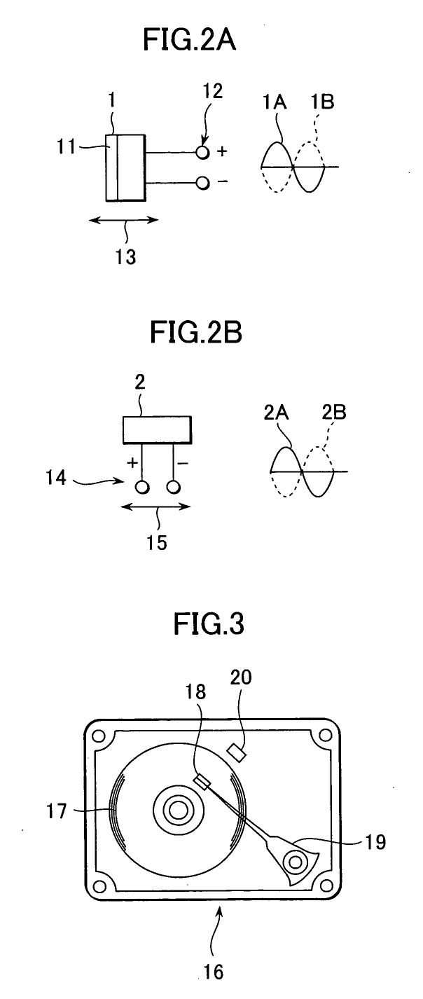

Then, the relationship between the microphone diaphragm and the sensor will be described in FIG. 2 A and FIG. 2B. Firstly, as described hereinabove, the sensor 2 is a device for obtaining an electrical signal in proportion to a mechanical vibration and one example of the device is a piezoelectric ceramic, a microphone unit with covered audio receiving face or the like. The sensor 2 has the direction of vibration with the maximum sensitivity and sensors have been developed to have various sensitivity detection directions 15 depending on the mounted location so that they may be used selectively depending on particular purposes.

The present invention features in that the vibration detection sensitivity directions 13, 15 of the microphone 1 and the sensor 2, which are used therein, are matched with each other to enhance the correlation between the two output signals, thereby reducing efficiently the vibration component in the subsequent stage adaptive processing.

In FIG. 2A and FIG. 2B, since the microphone 1 has the strongest vibration detection direction 13 in a perpendicular direction with respect to the diaphragm 11 (the left-right direction in the drawing), the generated vibration signal is also largest in that direction. Accordingly, if the microphone 1 and the sensor 2 are configured and disposed so that the vibration detection sensitivity direction 15 of the sensor 2 to be used is matched thereto, or in addition thereto, if the both are vibrated in the directions equal to the vibration detection sensitivity directions 13, 15 as shown by solid lines, outputted between their plus (+) and minus (−) terminals 12, 14 are the signal waveforms in the polarity of the solid lines 1A, 2A, while if vibrated in the directions of the vibration detection sensitivity directions 13, 15 as shown by dotted lines, outputted are the signal waveforms in the polarity as shown by dotted lines 1B, 2B, thereby further enhancing the correlation of the both output signals.

It is to be noted in the example of preferred embodiment of present invention that the microphone and the sensor are not necessarily required to dispose close to each other. For instance, in an example as shown in FIG. 3, a sensor 20 is mounted inside an HDD device 16. In this case, the sensor 20 is capable of picking up vibration generated from a rotary disk 17 which is driven by an internal spindle motor (not shown) as well as vibration caused at the time of moving a magnetic head 18 which is driven by a voice coil motor 19.

At this event, when the generated mechanical vibration and the acoustic vibration noise are inputted to the microphone, it is also possible to reduce such vibration component by the use of the embodiment 1 of the microphone apparatus in FIG. 1. In recent years, a disk device such as an HDD or the like is increasingly miniaturized and becomes portable, thereby possibly unexpected impact being applied onto such device. If such impact is applied, for example, while data is being recorded in designated addresses of the disk, such impact may move the magnetic head 18 and rewrite on address locations where other data have been written, thereby destroying the data. Accordingly, for the purpose of data protection in such case, a shock detection sensor is built inside the device for interrupting the writing operation whenever impact is detected. In the present invention, it is also possible to share the output of such shock sensor for the purpose of the sensor 20.

Now, a construction and an operation of the sensor will be described hereunder.

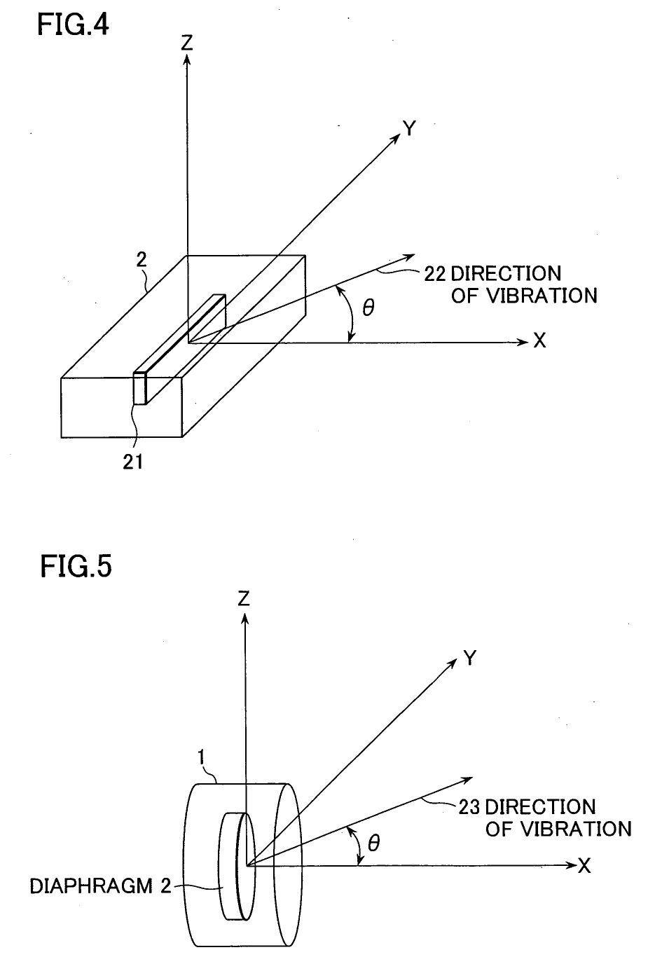

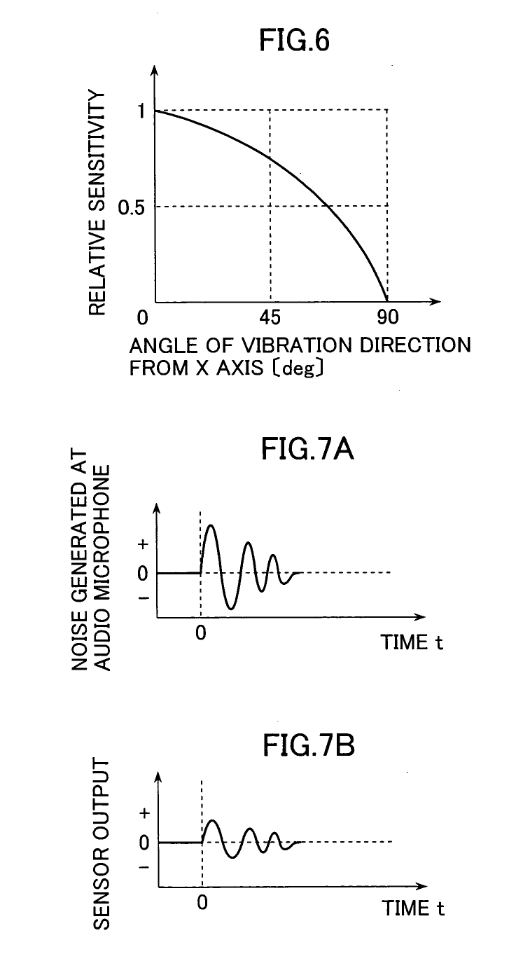

FIG. 4 shows an example of the sensor according to a preferred embodiment of the present invention. And FIG. 6 is a graph to show the output sensitivity of the sensor.

Firstly, FIG. 4 is an example of preferred embodiment of the present invention illustrating the construction of a vibration sensor using a piezoelectric ceramic 21 inside the sensor 2. Supposing mutually orthogonal X, Y and Z axes in the piezoelectric ceramic 21, it is assumed that the sensitivity is the maximum to the vibration in the direction of the X axis, the vibration direction 22 is from the direction of the X axis toward either direction of the Y or Z axis and the angle made by the vibration direction 22 and the X axis is represented by θ.

FIG. 6 is a relative output sensitivity characteristic of the sensor 2 with respect to the angle θ under the above conditions.

According to FIG. 6, assuming that the relative sensitivity is the maximum value 1 when the vibration direction 22 coincides with the X axis, it is understood that the sensitivity gradually decreases as the angle θ increases and the sensitivity drops to zero when vibration is in the horizontal direction including both Y and Z axes.

FIG. 5 shows an example of structure of the sensor. Concretely, FIG. 5 shows an example of structure of the vibration sensor using a microphone. The use of the microphone 1 as the vibration sensor can be achieved by closing the sound receiving face of the microphone 1. Again, in this case, supposing mutually orthogonal X, Y and Z axes with respect to the diaphragm 2 within the microphone 1, the sensitivity to vibration in the direction of the X axis is the maximum and the relative sensitivity decreases gradually as the angle θ of the actual vibration direction 23 increases from the direction of the X axis toward the direction of either the Y axis or the Z axis, which is similar to the relative output sensitivity characteristic as shown in FIG. 6.

Accordingly, as shown in FIG. 2A and FIG. 2B, the correlation between the noise included in the audio microphone 1 and the sensor output can be improved by matching the vibration detection direction 13 of the audio microphone 1 with the vibration directions as shown in FIG. 4 and FIG. 5 and also by mounting the sensor 2 in the direction so that the vibration directions are in agreement with the direction to maximize the sensitivity as shown in FIG. 6.

FIG. 7 shows polarity and delay time of the output of the sensor, wherein FIG. 7A is the noise generated in the audio microphone, while FIG. 7B is the sensor output.

At this event, the waveform correlation can be further improved by equalizing the polarities and delay times of the noise waveform generated in the audio microphone as shown in FIG. 7A and the sensor output waveform as shown in FIG. 7B. It is to be noted that the delay time is equalized by the delay unit 5 in the embodiment 1 of the microphone apparatus in FIG. 1.

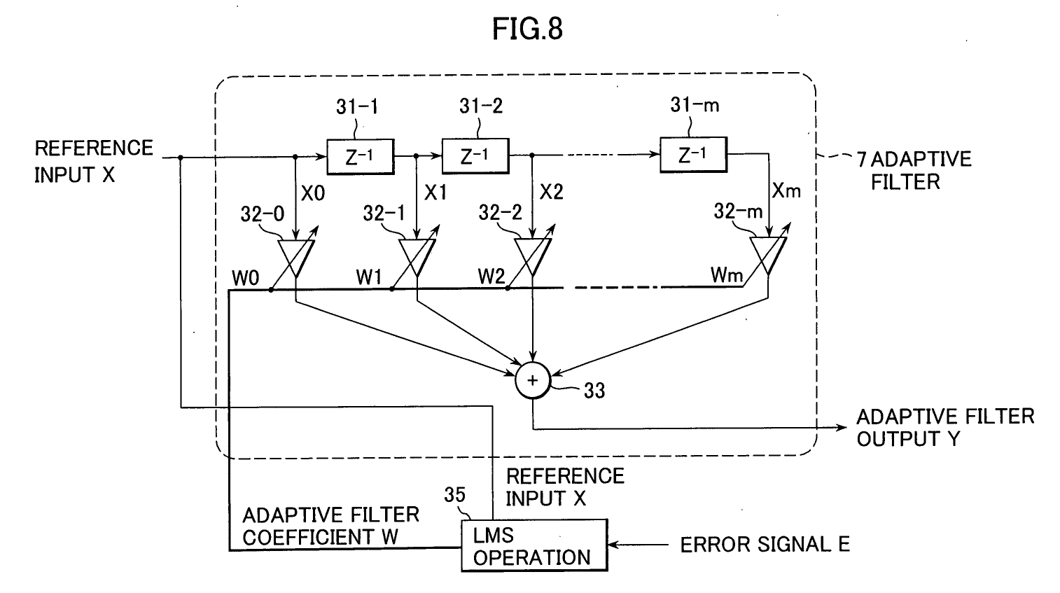

Now, the adaptive filter 7 as shown in FIG. 1 will be described hereunder by reference to FIG. 8. Various methods are proposed as algorithm for the adaptive filter 7. In general, because of a relatively fast converging speed and a small operation circuit scale, the LMS (Least Mean Square) method is frequently used and it is possible to perform processing by hardware such as a DSP (Digital Signal Processor) and a digital LSI (Large Scale Integration) and software installed in a microcomputer.

Firstly, a signal which has high correlation with the target noise to be rejected is inputted as the reference input X in FIG. 8. And the reference input X is applied to the adaptive filter 7 enclosed by the dotted line and also to an LMS operation processing unit 35. The adaptive filter 7 comprises an FIR (Finite Impulse Response) digital filter having a large number of taps, generally in the order of several hundreds and the filter coefficients W for the respective taps are adaptively renewed in accordance with the LMS algorithm. An FIR filter having (m+1) taps is shown herein. 31-1 through 31-m represent delays Zexp(−1) for a unit sampling time, X₁ through Xm represent signals with respective delays, 32-0 through 32-m represent multipliers for multiplying the coefficients and Wo through Wm represent coefficients for the multipliers. All outputs of the respective multiplier are added by an adder 33 before being outputted as the adaptive filter output Y. Accordingly, the adaptive filter output Y can be expressed by the convolution operation as given by the following mathematical expression 1.
(Mathematical Expression 1)

$$Y = {\sum }_{j = 0}^{m} ( Wj \cdot Xj )$$

Furthermore, the LMS operation processing unit 35 performs operations of the respective adaptive filter coefficients Wo through Wm in accordance with the following Mathematical Expression 2 based on the reference input X and the error signal E for renewing them.
Wk=Wk−1+2μ·Ek−1·Xk−1 (Mathematical Expression 2)

In Mathematical Expression 2, each small letter k represents sampling time passage. Assuming that Wk for the k-th sampling is the adaptive filter coefficient at present, Wk−1 represents the adaptive filter coefficient for the (k−1)-th sampling, i.e., the adaptive filter coefficient for the past sampling by 1. On the other hand, μ is known as the step gain or the step size, which is a parameter to determine the converging speed in the LMS algorithm. Since a larger μ value means faster converging speed but poorer in accuracy after conversion, while a smaller μ value means slower converging speed but increases accuracy after conversion. Optimum value is set depending on the conditions of the adaptive system to be used. On the other hand, the inputted error signal E will be described hereinafter.

Now, the LMS operation processing unit 35 renews the aforementioned adaptive filter coefficient W in accordance with Mathematical Expression 2 so that the signal having high correlation to the reference input X included in the error signal E will be always minimized.

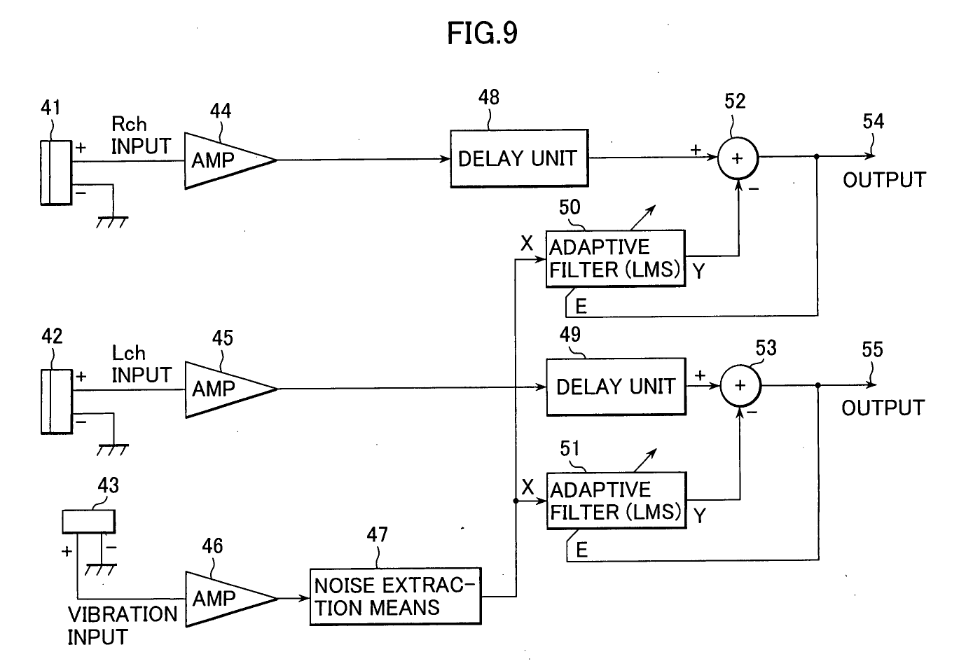

Then, description will be made on FIG. 9 which shows a second example of microphone apparatus according to a preferred embodiment of the present invention.

FIG. 9 differs from FIG. 1 in that a plurality of microphones is employed such as, for example, in the case of a stereophonic 2 channel inputs. In case of the present invention, it is unnecessary to dispose a plurality of microphone units at a shorter distance from each other than the wavelength of the input audio signal or in an opposed relationship like the case of the earlier patent application, thereby enabling to dispose the microphone units at any desired distance. Also, since directional microphones can be freely selected, the directional operation processing which is required at the subsequent stages in the earlier patent application is no longer required.

Firstly, microphones 41, 42 are respectively right channel (Rch) and left channel (Lch) microphone units used for audio input similarly to the microphone 1 in FIG. 1, while a sensor 43 is used for vibration input similarly to the sensor 2 in FIG. 1. They are processed in the similar circuit construction to FIG. 1. However, since adaptive filters 50, 51 operate independently, different vibration dependent noises are respectively optimized and reduced in Lch and Rch. Although description is made on the case of stereophonic 2 channels including Lch and Rch herein, it is possible to perform the adaptive operation using a single sensor even in multi-channel cases. However, detailed operations in such cases are omitted herein because of similarity to the case in FIG. 1.

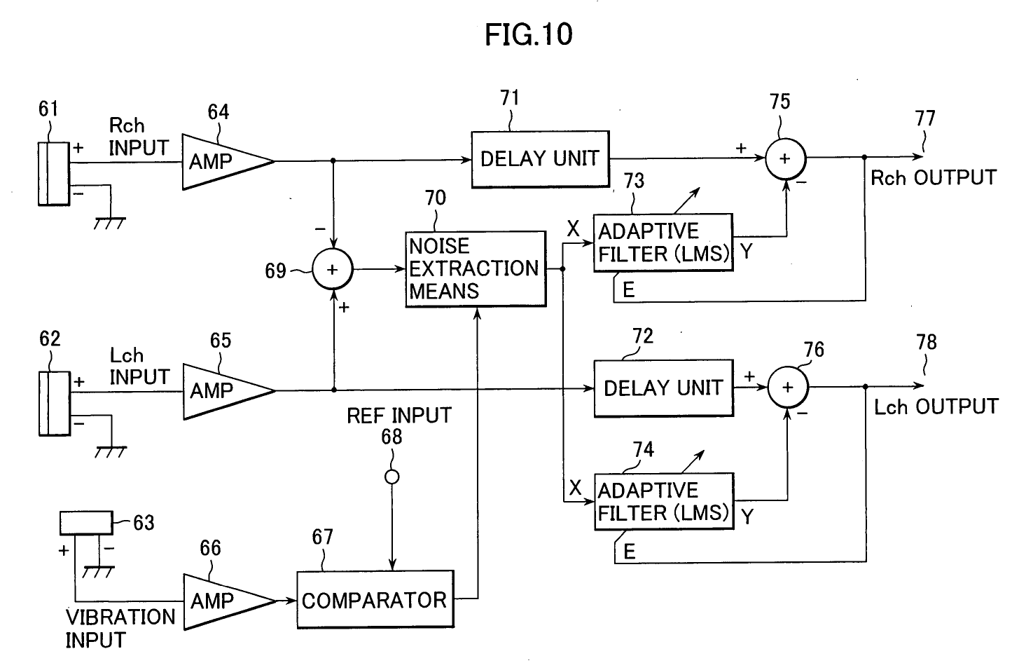

Now, a description will be made hereunder on a third example of the microphone apparatus according to a preferred embodiment of the present invention, as shown in FIG. 10. However, no description will be made on functional blocks similar to those in the embodiment as shown in FIG. 9. Microphones 61, 62 are respectively Rch and Lch microphone units whose output signals are connected to − side and + side terminals of an adder 69 by way of amplifiers AMP 64, 65, respectively. A difference output of the both signals is inputted to noise extraction means 70. On the other hand, the output of a sensor 63 is inputted to a comparator 67 by way of an amplifier AMP 66 and is compared with a level from a reference (REF) input 68 which is set separately. And a comparison result from the comparator 67 is outputted to the aforementioned noise extraction means 70.

The difference component (differential component) of the output signals of the microphone 61 and the microphone 62, which is outputted from the aforementioned adder 69, contains a large portion of difference signals between the audio signals due to different mounting locations of the respective microphones and also the vibration signal. This is caused due to difference in spatial distance from the sound source for the audio signals, while due to difference in transfer function from the vibration source for the vibration signal. Incidentally, in case of a video recording apparatus with a built-in camera, it is most likely that the sound source is located sufficiently long distance as compared to the distance of mounting the microphones. On the other hand, since vibration source in the video recording apparatus with a built-in camera is within the main body of the recording apparatus, such vibration propagates from the distance substantially equal to the distance between the mounted microphones. Accordingly, the sound signals which are inputted to the microphone 61 and the microphone 62 are relatively equal distance with respect to the sound source, thereby having a high correlation. Since the vibration signal has a lower correlation than the audio signal, subtraction of these signals by the aforementioned adder 69 may result in producing more vibration signal than the audio signal.

Moreover, if the aforementioned comparator 67 is configured, for example, to output an ON signal when the vibration signal outputted from the sensor 63 is larger than the level set by the REF input 68, while outputting an OFF signal when it is smaller, the ON/OFF binary signal is inputted to the noise extraction means 70. By configuring the noise extraction means 70 to extract noise and output the vibration signal component when it is ON, while outputting a zero signal when it is OFF, it is possible to extract only the vibration signal which is then inputted to the adaptive filters 73, 74. A detailed description will be omitted because it operates similar to FIG. 1. In this manner, noise rejection can be performed only for the noise which exceeds a designated reference level.

It is to be noted in the example of preferred embodiment of the apparatus as shown in FIG. 10 that the microphones 61, 62 may be disposed in an opposed relationship like the earlier patent application. It is also possible to add more microphones for easily multi-channeling.

Although one sensor is used in the embodiments mentioned as shown in FIG. 1, FIG. 9 and FIG. 10, it is possible to use a plurality of sensor outputs so as to add respective outputs before being inputted to the noise extraction means. In this case, it is possible to input or detect vibrations at a plurality of locations. Moreover, in case of using a plurality of sensors, it is not necessary to commonly input the output of the noise extraction means to each adaptive filter but rather input to any desired adaptive filter from a plurality of noise extraction means in conformity with respective sensors.

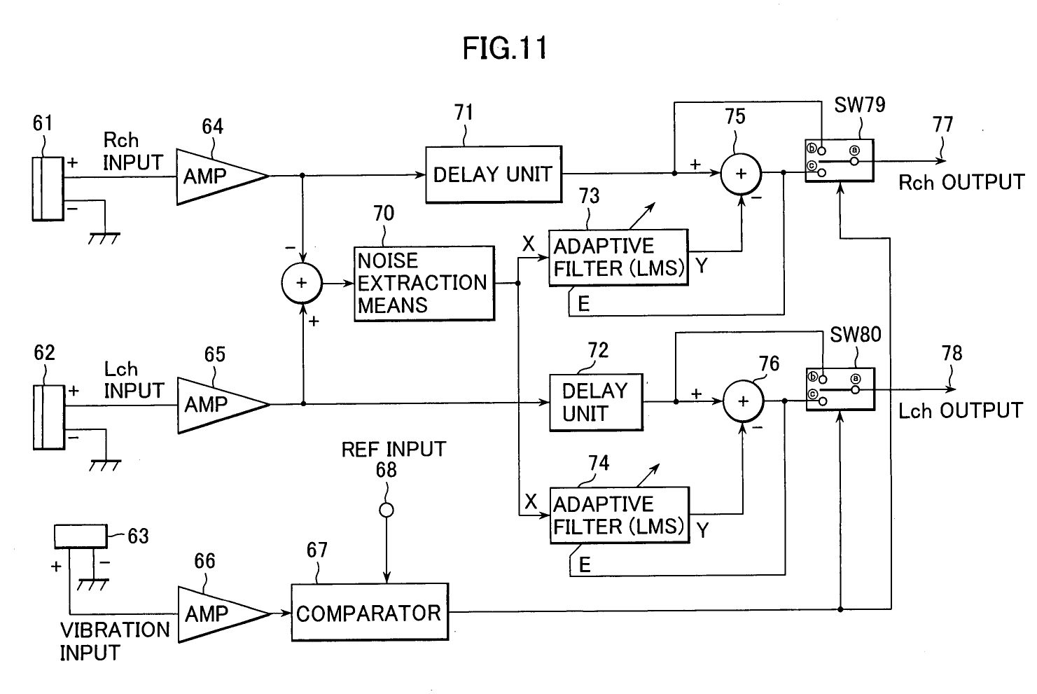

Now, description will be made hereunder on a fourth example of the microphone apparatus according to another preferred embodiment of the present invention as shown in FIG. 11. It is to be noted that the same reference numbers are used herein to refer to the same mechanism blocks as those in the third embodiment as shown in FIG. 10 and description will be made on only difference function blocks.

Firstly, FIG. 11 differs from the embodiment as shown in FIG. 10 in that the ON signal of the comparator 67 is connected to switches SW 79, 80. By selectively connecting movable contacts a to either fixed contacts b or c, the switches SW 79, 80 enable to select either output after or before performing noise reduction processing for each of the Lch and Rch. At the time when the ON signal is outputted, the movable contact is connected to the fixed contact c for outputting the noise reduced output from the Rch terminal 77 and the Lch terminal 78. On the other hand, at the time when the OFF signal is outputted, the movable contact is connected to the fixed contact b for outputting the noise non-reduced output from the Rch terminal 77 and Lch terminal 78. In this manner, only noise which exceeds the further designated reference level can be selectively rejected.

It is to be noted that the reference signal to be inputted to the adaptive filters 73, 74 in FIG. 10 is ON/OFF for turning on or off the outputs of the adaptive filters 73, 74. On the other hand, FIG. 11 differs in that the noise extraction means 70 always outputs the vibration signal component and that the adaptive filters 73, 74 always remain operating. Accordingly, the sensor output does not participate in the operation of the adaptive filters 73, 74.

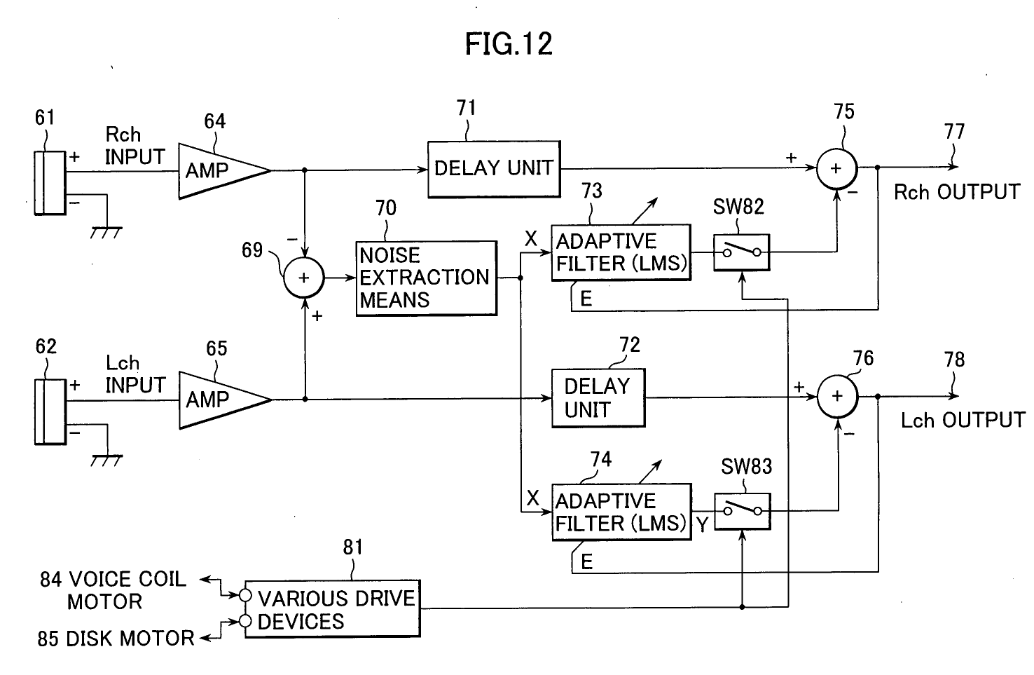

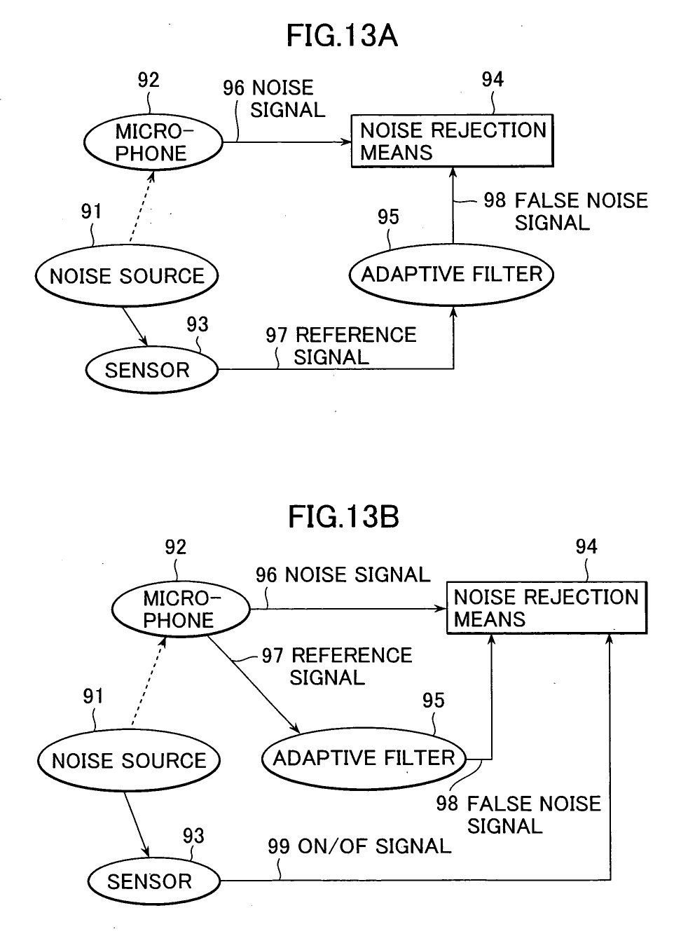

Furthermore, description will be made on a fifth example of the microphone apparatus according to another preferred embodiment of the present invention as shown in FIG. 12. In FIG. 12, no new vibration detection sensor is employed and the motor which is a vibration source is, for example, a voice coil motor 84 for driving a magnetic head installed in an HDD device or a disk motor 85 which is a spindle motor for driving a rotary disk. The ON/OFF signal is directly obtained from various drive devices 81 for controlling such motors and on/off controls the outputs of the adaptive filters 73, 74 by the switches SW 82, 83. At the time when the signal is ON, the contacts are connected so as to supply noise reduced outputs to the Rch terminal 77 and Lch terminal 78. On the other hand, at the time when the signal is OFF, the contacts are opened so as to supply noise non-reduced outputs to the Rch terminal 77 and the Lch terminal 78. In this manner, it is further possible by selecting only noise in excess of a definite reference level to perform by a magnetic head the recording operation of the noise reduced microphone signal in a rotary disk which is a recording medium in the recording apparatus.

Generally, these motors have various built-in sensors for rotation and phase servo purposes, thereby reading out such information as the current rotation speed and phase. Such information is supplied to the various drive units 81 depending on the purposes of optimizing the drive. Therefore, since the ON/OFF signal is obtained from the various drive devices 81 in synchronism with the drive signal for the motors 84, 85 which are noise sources, it is similarly possible to turn on or off the noise reduction function by applying such signal to control terminals of the switches SW 82, 83. Although the switches SW 82, 83 for disconnecting or opening the outputs are connected to the adaptive filters 73, 74 in FIG. 12, it is also possible to switch the noise reduced processing system and the noise non-reduced processing system as is the case in FIG. 11.

The present invention can be applied to noise reduction processing of a driving motor in a disk device such as an HDD device, a DVD, a CD, a CD-R or the like which is installed in, for example, a recording apparatus with a built-in camera.

Furthermore, it should be understood by those of ordinary skill in the art that the descriptions above show mere examples of preferred embodiments of the present invention. Therefore, the present invention should not limited to such embodiments, so that many other modifications, variations, combinations, sub-combinations, etc. of such embodiments and equivalents thereof may be made without departing from the scope and spirit of the present invention.

1. A microphone apparatus comprising:
at least one microphone;
at least one sensor;
noise extraction means for extracting a noise bandwidth section from an output signal from the sensor;
adaptive filter corresponding to the microphone which receives the output signal of the noise extraction means as a reference input signal; and
operation means for subtracting the output signal of the adaptive filter from the output signal of the respective microphone; wherein
directions of vibration detection of the microphone and the sensor match, or output polarities of the vibration signals of the microphone and the sensor match.

2. A microphone apparatus comprising:
a plurality of microphones;
at least one sensor;
first operation means for outputting a differential component between the output signals of the plurality of microphones;
noise extraction means for extracting a noise bandwidth section from the output signal of the first operation means;
adaptive filter corresponding to each microphone for receiving the output signal of the noise extraction means as a reference signal; and
second operation means for subtracting the output signal of the adaptive filter from the output signal of each microphone; wherein:
directions of vibration detection of the microphone and the sensor match, or, in addition, output polarities of the vibration signals of the microphone and the sensor match; and
noise reduction is inhibited by not carrying out the subtraction by the second operation means if the signal level of the sensor is equal to a designated level or lower.

3. A noise reduction method of a microphone apparatus having at least one microphone; at least one sensor; a noise extraction means for extracting a noise bandwidth section from an output signal from the sensor; an adaptive filter corresponding to the microphone receiving the output signal of the noise extraction means as a reference input signal; and an operation means for subtracting the output signal of the adaptive filter from the output signal of the respective microphone; wherein directions of vibration detection of the microphone and the sensor match, or in addition output polarities of the vibration signals of the microphone and the sensor match; the method comprising the steps of:
extracting a noise bandwidth section from the output signal of the sensor by means of the noise extraction means;
outputting a pseudo noise signal corresponding to each microphone by inputting the output signal of the noise extraction means by means the adaptive filter, and
subtracting the output signal of the adaptive filter from the output signal of the respective microphone by the operation means.

4. A noise reduction method for a microphone apparatus having a plurality of microphones; at least one sensor; a first operation means for outputting a differential component between output signals from the plurality of microphones; a noise extraction means for extracting a noise bandwidth section from an output signal of the first operation means; an adaptive filter corresponding to each microphone for receiving an output signal of the noise extraction means as a reference signal; and second operation means for subtracting an output signal of the adaptive filter from the output signal of each microphone; wherein directions of vibration detection of the microphone and the sensor match, or in addition output polarities of the vibration signals of the microphone and the sensor match; the method comprising the steps of:
outputting a differential component between the output signals of the plurality of microphones by means of the first operation means;
extracting a noise bandwidth section in the output signal of the first operation means;
outputting a pseudo noise signal corresponding to each microphone with the output signal of the noise extraction means as the reference input signal by means of the adaptive filter;
subtracting the output signal of the adaptive filter from the output signal of the respective microphone by means of the second operation means; and
prohibiting the subtraction by the second operation means if the signal level of the sensor is equal to a designated level or lower.

5. A microphone apparatus comprising:
at least one microphone;
at least one sensor;
noise extraction means for extracting a noise bandwidth section from an output signal of the sensor;
adaptive filter for the microphone receiving the output signal of the noise extraction means as the reference input signal; and
operation means for subtracting the output signal of the adaptive filter from the output signal of the respective microphone, thereby recording the output signal of the microphone on a recording medium by means of a recording means which is driven by a driving means; wherein
vibration detection directions of the microphone and the sensor match, or, in addition, output polarities of the vibration signals of the microphone and the sensor match.

6. A recording apparatus for recording an output signal of a microphone apparatus having a plurality of microphones; at least one sensor; first operation means for outputting difference components between output signals of the plurality of microphones; noise extraction means for extracting a noise bandwidth section from an output signal of the first operation means; an adaptive filter for each microphone for receiving the output signal of the respective microphone as a reference input signal; and second operation means for subtracting an output signal of the adaptive filter from the output signal of the respective microphone; wherein:
vibration detection directions of the microphone and the sensor in the microphone apparatus match, or output polarities of the vibration signals of the microphone and the sensor match; and
noise reduction is prohibited by not performing subtraction by the second operation means if a signal level of the sensor is equal to a designated level or lower.
